(19) United States
(12) Patent Application Publication
(10) Pub. No.: US 2015/0006486 A1
(43) Pub. Date: Jan. 1, 2015

(54) METHOD AND APPARATUS FOR STORING DATA

(71) Applicant: TENCENT TECHNOLOGY (SHENZHEN) COMPANY LIMITED, Shenzhen (CN)

(72) Inventors: Aimin Lin, Shenzhen (CN); Jiong Tang, Shenzhen (CN); Junshuai Wang, Shenzhen (CN)

(21) Appl. No.: 14/478,151

(22) Filed: Sep. 5, 2014

Related U.S. Application Data
(63) Continuation of application No. PCT/CN2013/072042, filed on Mar. 1, 2013.

(30) Foreign Application Priority Data
Mar. 9, 2012 (CN) 201210061555.8

(51) Int. Cl. G06F 17/30; G06F 3/06

(52) U.S. Cl. CPC G06F 17/30581; G06F 3/0604; G06F 3/0656; G06F 3/067; G06F 2003/0691
USPC 707/634; 709/214

(57) ABSTRACT

Examples of the present disclosure disclose a method and an apparatus for storing data. In the method, an extendable two-dimensional data buffer array is configured in a local shared memory according to a preset configuration policy, the two-dimensional data buffer array comprising multiple logic data blocks, and each of the multiple logic data blocks comprising multiple sub data blocks for storing data. Data on a network storage device is stored into a sub data block corresponding to the data according to requirements of service logic. According to the examples of the present disclosure, the data is stored locally, thereby improving efficiency of data storage and data exchange. In addition, the extendibility of data structure is improved since the two-dimensional data buffer array for storing data is extendable, and thus the requirement of the service logic is satisfied.

### CROSS-REFERENCE TO RELATED APPLICATIONS

This application is a continuation of International Patent Application No. PCT/CN2013/072042, filed on Mar. 1, 2013. This application claims the benefit and priority of Chinese Application No. 201210061555.8, filed Mar. 9, 2012. The entire disclosures of each of the above applications are incorporated herein by reference.

### TECHNICAL FIELD

The present disclosure relates to computer technologies, and more particularly, to a method and an apparatus for storing data.

### BACKGROUND

With the development of computer technologies, game technologies develop rapidly. The number of people participated in a game is increased from single to multiple. As the number of people increases, the amount of data generated during the game is increased, and thus service logic becomes more complicated. It is important for game manufactures to effectively store data generated by the service logic so as to provide better services to users.

In conventional solutions, when the data generated by the service logic is stored, the data generated by the service logic is transmitted to a network storage device via a network and stored in a database on the network storage device. A buffer space is established on the network storage device, and data having high exchange frequency is stored in the buffer space, so as to improve the speed of the data exchange.

However, in the game technology, the data are updated frequently, and it is required to access the network storage device via the network repeatedly no matter whether the data generated by service logic is stored in the buffer space of the network storage device or stored in the database of the network storage device. The procedure of accessing the network storage device via the network may reduce storage efficiency, and may influence the efficiency of subsequent data exchange. In addition, if data structures of the database are fixed and not extendable, requirements of data structure variation as required by the service logic will not be satisfied.

### SUMMARY

Examples of the present disclosure provide a method and an apparatus for storing data, so as to improve data storage efficiency while improve the extendibility of data structure, and satisfy the requirement of the service logic.

A method for storing data includes:

configuring an extendable two-dimensional data buffer array in a local shared memory according to a preset configuration policy; the two-dimensional data buffer array comprising multiple logic data blocks, and each of the multiple logic data blocks comprising multiple sub data blocks for storing data; and

storing data on a network storage device into a sub data block corresponding to the data according to requirements of service logic.

An apparatus for storing data includes:

a configuration module, configured to configure an extendable two-dimensional data buffer array in a local shared memory according to a preset configuration policy; the two-dimensional data buffer array comprising multiple logic data blocks, and each of the multiple logic data blocks comprising multiple sub data blocks for storing data; and

a loading module, configured to storing data on a network storage device into a sub data block corresponding to the data according to requirements of service logic.

The data is stored locally by configuring the extendable two-dimensional data buffer array in the local shared memory according to the preset configuration policy and storing the data on the network storage device into the sub data block corresponding to the data according to the requirements of the service logic, thereby improving the efficiency of data storage and data exchange. The extendibility of the data structure is improved since the two-dimensional data buffer array for storing data is extendable, and thus the requirements of the service logic are satisfied. In addition, the data in the local shared memory and the network storage device are synchronized by synchronizing modified data to the network storage device after the data in the data block is modified, and thus data loss is avoided.

### BRIEF DESCRIPTION OF THE DRAWINGS

In order to describe technical solutions of examples of the present disclosure clearly, accompanying drawings used in examples of the present disclosure are described below. The described accompanying drawings are parts of examples of the present disclosure. Other accompanying drawings may be obtained by those skilled in the art without creative labour based on the accompanying drawings of the present disclosure.

FIG. 1 is a schematic flowchart illustrating a method for storing data according to an example of the present disclosure.

FIG. 2 is a schematic diagram illustrating a structure of a system for storing data according to an example of the present disclosure.

FIG. 3 is a schematic flowchart illustrating a method for storing data according to another example of the present disclosure.

FIG. 4 is a schematic diagram illustrating transformation of data statuses according to an example of the present disclosure.

FIG. 5 is a schematic diagram illustrating a logic data block according to an example of the present disclosure.

FIG. 6 is a schematic diagram illustrating relationship tables according to an example of the present disclosure.

FIG. 7 is a schematic diagram illustrating an apparatus for storing data according to an example of the present disclosure.

FIG. 8 is a schematic diagram illustrating an apparatus for storing data according to an example of the present disclosure.

FIG. 9 is a schematic diagram illustrating an apparatus for storing data according to an example of the present disclosure.

FIG. 10 is a schematic diagram illustrating an apparatus for storing data according to an example of the present disclosure.

FIG. 11 is a schematic diagram illustrating an apparatus for storing data according to an example of the present disclosure.

FIG. 12 is a schematic diagram illustrating an apparatus for storing data according to an example of the present disclosure.

FIG. 13 is a schematic diagram illustrating an apparatus for storing data according to an example of the present disclosure.

### DETAILED DESCRIPTION

In order to make the object, technical solution and merits of the present disclosure clearer, the present disclosure will be illustrated in detail hereinafter with reference to the accompanying drawings and specific examples.

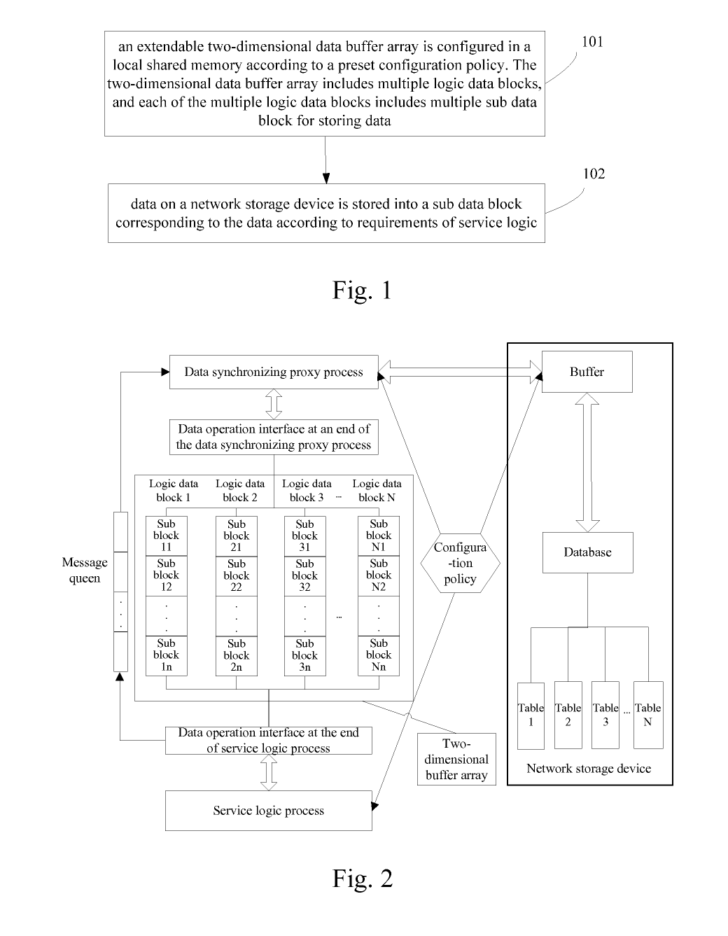

According to an example of the present disclosure, a method for storing data is provided. Referring to FIG. 1, the method includes the following processing.

At 101, an extendable two-dimensional data buffer array is configured in a local shared memory according to a preset configuration policy. The two-dimensional data buffer array includes multiple logic data blocks, and each of the multiple logic data blocks includes multiple sub data block for storing data.

At 102, data on a network storage device is stored into a sub data block corresponding to the data according to requirements of service logic.

According to an example, after the extendable two-dimensional data buffer array is configured in the local shared memory according to the preset configuration policy, the following processing is further included. A data status is configured for each of the multiple sub data blocks according to a data storage situation in each of the multiple sub data blocks. The data status is one of a free status, a loading status, a normal status, a modify status, a remove status and a tick_remove status.

According to an example, after the data on the network storage device is stored into the sub data block corresponding to the data according to requirements of the service logic, the following processing is further included. Data stored in the sub data block corresponding to the service logic is modified, and the modified data is synchronized to the network storage device. According to an example, the following processing is performed when synchronizing the modified data to the network storage device, the data status of each of the multiple the sub data blocks are polled regularly, and when the data status of a sub data block is the modify status, the data in this sub data block is synchronized to the network storage device. Further, after the data in this sub data block is synchronized to the network storage device, the data status of this sub data block is modified into the normal status.

According to an example, after the data on the network storage device is stored into the sub data block corresponding to the data according to the requirements of the service logic, the following processing is further included. Data stored in the sub data block corresponding to the service logic is synchronized to the network storage device, and the shared memory corresponding to the sub data block is removed. According to an example, the following processing is performed when synchronizing the data stored in the sub data block corresponding to the service logic to the network storage device, the data status of each of the multiple sub data blocks are queried, and the data of a sub data block in the tick_remove status is synchronized to the network storage device. Further, after the data of the sub data block in the tick_remove status is synchronized to the network storage device, the data status of the sub data block in the tick_remove status is modified into the free status.

According to an example, when storing the data on the network storage device into the sub data block corresponding to the data according to the requirements of the service logic, a sub data block in the free status is selected from all of the multiple sub data blocks, and the data on the network storage device is stored into the selected sub data block according to the requirements of the service logic. Further, after the data on the network storage device is stored into the selected sub data block, the data status of the selected sub data block is modified from the free status into the loading status. After the loading of the data is completed, the data status of the selected sub data block is modified from the loading status to the normal status.

According to an example, after the extendable two-dimensional data buffer array is configured in the local shared memory according to the preset configuration policy, a relationship table of the two-dimensional data buffer array and the network storage device, is established and updated according to the changing of data in the sub data blocks of the two-dimensional data buffer array. The relationship table is stored on the network storage device, and records a data storage situation of each of the sub data blocks of the two-dimensional data buffer array. Each of the logic data blocks in the two-dimensional data buffer array corresponds to one relationship table, and each of the sub data blocks in the logic data block corresponds to a record in the relationship table.

By using the method according to the example, the extendable two-dimensional data buffer array is configured in the local shared memory according to the preset configuration policy, and the data on the network storage device is stored into the sub data block corresponding to the data according to the requirements of the service logic. Therefore, the data are stored locally, and the efficiency of data storage and data exchange is improved. The extendibility of the data structure is improved since the two-dimensional data buffer array for storing data is extendable, and thus the requirements of the service logic are satisfied. In addition, after the data in the sub data block is modified, the modified data is sent to the network storage device, so that the data in the local shared memory and the network storage device are synchronized, and thus data loss is avoided.

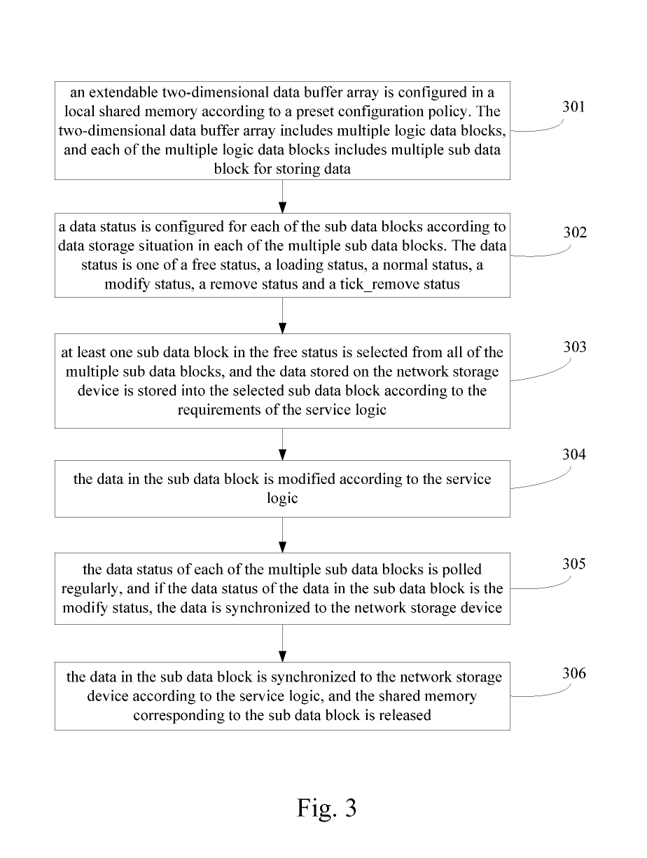

According to another example of the present disclosure, a method for storing data is provided. According to the method, an extendable two-dimensional data buffer array is configured in a local shared memory, and data continuously varies as system runs are stored both in a network storage device and sub data blocks of the two-dimensional data buffer array. For convenience of description, the method will be described with reference to a data storage system shown in FIG. 2. Referring to FIG. 3, the method includes the following processing.

At 301, an extendable two-dimensional data buffer array is configured in a local shared memory according to a preset configuration policy. The two-dimensional data buffer array includes multiple logic data blocks, and each of the multiple logic data blocks includes multiple sub data block for storing data.

According to an example, the preset configuration policy is used to configure the number of the logic data blocks in the two-dimensional data buffer array and to configure the number and the capacity of the sub data blocks in each of the logic data block, thereby extending the data structure. In an example of the present disclosure, the extending of the data structure includes increasing or reducing the number of the logic data blocks in the two-dimensional data buffer array, and increasing or reducing the number and capacity of the sub data blocks in each of the logic data block. The configuration policy may be set according to practical requirements. For example, the number of the logic data blocks and the number and capacity of the sub data blocks configured in the configuration policy may be set according to a data structure required by the service logic, or may set in other manners. The number of the logic data blocks and the number and capacity of the sub data blocks configured in the configuration policy are not limited in the example. The local shared memory refers to a large capacity memory which may be accessed by different Central Processing Units (CPUs) in a computer system with multiple processors. The local shared memory may be read or written directly, thereby improving processing efficiency of the processors.

At 301, in conjunction with the structure of the data storage system shown in FIG. 2, a process may be called to configure the extendable two-dimensional data buffer array in the local shared memory, the process is one of service logic process and a data synchronizing proxy process which is first started. For example, if the service logic process is first launched than the data synchronizing proxy process, the extendable two-dimensional data buffer array may be configured by the service logic process in the local shared memory according to the preset configuration policy, and if the data synchronizing proxy process is first launched than the service logic process, the extendable two-dimensional data buffer array may be configured by the data synchronizing proxy process in the local shared memory according to the preset configuration policy. Regardless of the process used to perform the configuration, application for the local shared memory according to the preset configuration policy is performed first, and then the two-dimensional data buffer array is configured in the applied local shared memory. The configured two-dimensional data buffer array includes multiple logic data blocks, and each of the logic data blocks includes multiple sub data blocks for storing data. The sub data blocks may be identified in a manner of coordinate so as to distinguish the sub data blocks in different logic data blocks. As shown in FIG. 2, as an example, the configured two-dimensional data buffer array includes N logic data blocks, and each logic data block includes n sub data blocks, the nth sub data block in the Nth logic data block may be identified with two-dimensional data coordinate (N, n).

According to an example, regardless of the manner used for identifying the sub data blocks, each of the sub data blocks may be used to store data. The logic data blocks in the two-dimensional data buffer array, according to logic functions, may be classified into dynamic logic data blocks and static logic data blocks. The sub data blocks in the dynamic logic data blocks are used for storing dynamic data, and the sub data blocks in the static logic data blocks are used for storing static data. The dynamic data includes data which may be loaded, removed and synchronized dynamically, and the shared memory space corresponding to the sub data blocks for storing the dynamic data may be used repeatedly. When taking game player role data in the service logic as an example, role online and offline relate to data synchronizing pulling and storing. The static data is stored in the shared memory, and is not removed once the static data is loaded, so that there is no need to releasing the shared memory space corresponding to the sub data blocks for storing static data, and the static data, such as data of market hall of games, is synchronized to the network storage device using timing mechanism. The logic data blocks are not limited to dynamic logic data blocks or static logic data blocks in the example, and in practice, the logic data blocks may be configured according to the configuration policy.

According to an example, after the two-dimensional data buffer array is configured, the two-dimensional data buffer array is configured in the shared memory, and addresses of the logic data blocks and addresses of the sub data blocks are physical addresses of the shared memory, while an address of the service logic process and an address of the data synchronizing proxy process both are logic addresses. Hence, it is needed that the memory space of the two-dimensional data buffer array is mapped to the memory space of the process configuring the two-dimensional data buffer array, i.e., the physical addresses are translated into logic addresses, so that that the data in the configured two-dimensional data buffer array may be operated by the service logic process and/or data synchronizing proxy process subsequently. The memory space of the two-dimensional data buffer array may be mapped to the memory space of the other process which is not used to configure the two-dimensional data buffer array, after this process is launched.

It is to be noted that, after the two-dimensional data buffer array is configured, the two-dimensional data buffer array and data stored in the two-dimensional data buffer array are maintained successionally and individually, as long as the system is not powered off, the memory is not cleaned or damaged manually. In other words, once the configuration of the two-dimensional data buffer array is completed, the data structure of the two-dimensional data buffer array and data therein is always exist, in the case that the system is not powered off, and the memory exists. If the system is powered off, or the memory is cleaned or damaged, the two-dimensional data buffer array should be re-configured. No matter whether the system is powered off and whether the memory is modified or damaged, the translation between the physical addresses and the logic addresses is required to be performed again, if the service logic process or the data synchronizing proxy process is re-started.

At 302, a data status is configured for each of the sub data blocks according to data storage situation in each of the multiple sub data blocks. The data status is one of a free status, a loading status, a normal status, a modify status, a remove status and a tick_remove status.

According to an example, after the two-dimensional data buffer array is configured at 301, the data status of each of the multiple sub data blocks is set according to the data storage situation in each of the sub data blocks, and the data status of each of the sub data blocks includes, but not limited to the following six data statuses:

1. free: data is to be assigned;

2. loading: data being loaded;

3. normal: dada is loaded;

4. modify: data is modified;

5. remove: data is stored and is being removed;

6. tick_remove: if data removal fails, the data status of the sub data block is configured as this status, so that the data may be removed regularly by regularly control until the data is removed successfully.

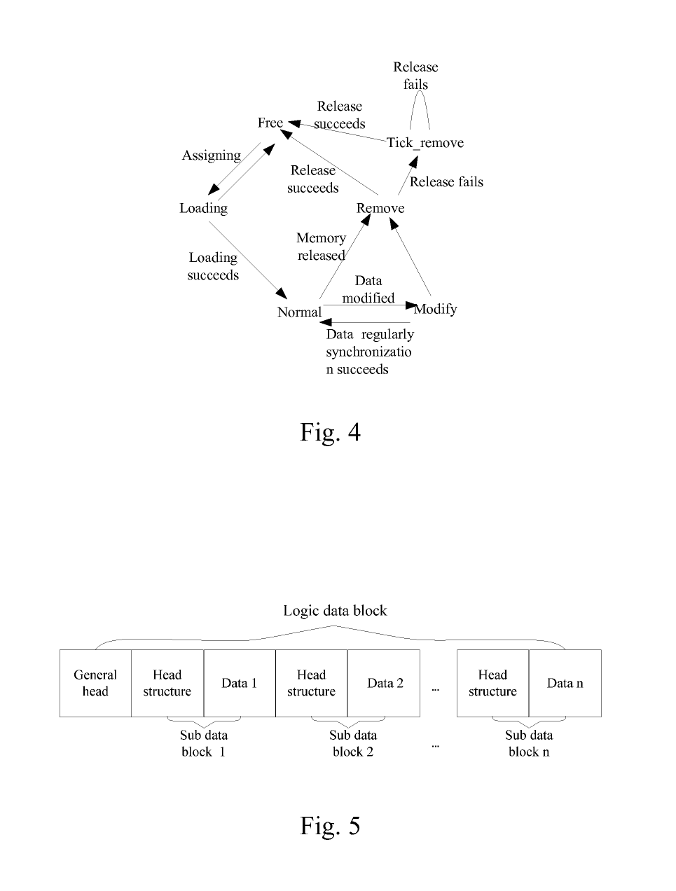

In the procedure of storing and updating the data, the data status of the sub data blocks may vary among the above mentioned six statuses, as shown in FIG. 4. When the two-dimensional data buffer array is initially configured, no data is stored in the sub data blocks of the two-dimensional data buffer array, and thus the data statuses of the sub data blocks are free statuses and may be updated timely according to the variation of the data storage subsequently.

After the data status of each of the sub data blocks is configured, the configuration of the two-dimensional data buffer array is completed. Each of the logic data blocks of the two-dimensional data buffer array may be consisted of a general head and sub data blocks. Taking a structure of the logic data block shown in FIG. 5 as an example, the general head of the logic data block includes 4 bytes for recording the length of the data stored in the logic data block. Each of the sub data blocks is consisted of a head structure and data, and the head structure of the sub data block may be as follows.

header
{
Key // key value corresponding to the data
Ver //version No. of the data
Time // modifying time of the data
Status // status of the data
}

The key value of the data in the sub data block is identical with a key of the data in the network storage device. Hence, no matter whether the data is stored in the local shared memory or stored in the network storage device, the key for each data is unchanged, which facilitates searching for data stored in difference places. After the two-dimensional data buffer array is configured, when a sub data block is assigned with data, the key, ver, time, and status values of the head structure of the sub data block are modified accordingly, and the sub data block will not be assigned with data again, unless the data in the sub data block is removed and the status of the sub data block is the free status. When the data in a sub data block is removed, the data in the sub data block is cleaned accordingly and the key, ver, time and status values of the head structure of the sub data block is modified.

According to an example, since the sub data blocks in the two-dimensional data buffer array are used for storing data, in order to keep the synchronization of the data in the local shared memory and the data in the network storage device, the following processing is performed after configuring the two-dimensional data buffer array.

A relationship table of the two-dimensional data buffer array and the network storage device is established, and the relationship table is updated according to data variation in the sub data blocks of the two-dimensional data buffer array. The relationship table is stored on the network storage device, and records the data storage situation of each of the sub data blocks of the two-dimensional data buffer array.

According to an example, each of the logic data blocks in the two-dimensional data buffer array corresponds to one relationship table, and each of the sub data blocks in the logic data block corresponds to a record in the mapping relationship table.

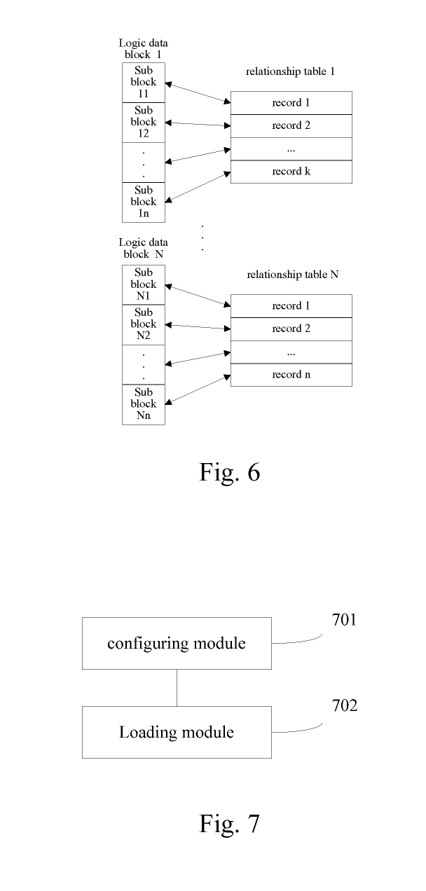

FIG. 6 is a schematic diagram illustrating relationship tables according to an example of the present disclosure. As shown in FIG. 6, one logic data block in the two-dimensional data buffer array corresponds to one relationship table stored in a database, and the relationship table records a structure of the logic data block. Each of the sub data blocks in the logic data block corresponds to a record in the relationship table, and the size of each data is fixed and corresponds to the size of the structure of the sub data blocks in the logic data blocks. In addition, since the data in the sub data block sometimes may be modified, the record in the relationship table corresponding to the sub data block may be updated accordingly. According to an example, after the relationship table is established, the relationship table is required to be updated according to data variation in the sub data block.

Thus, storage and interaction of the local data are ensured by the configuration operations performed at 301 to 302.

At 303, at least one sub data block in the free status is selected from all of the multiple sub data blocks, and the data stored on the network storage device is stored into the selected sub data block according to the requirements of the service logic.

In this processing, the data stored on the network storage device is stored into the two-dimensional data buffer array of the local shared memory, and thus achieves local data storage, so as to solve the low efficiency problem caused by connecting to the network storage device via the network each time when storing data and performing data exchange. When the data stored on the network storage device is to be stored into the local shared memory, whether there is free memory is to be determined first. Since the data storage situation of each of the sub data blocks is identified by the data status, and thus a sub data block whose data status is the free status may be selected from all of the sub data blocks, and the data stored on the network storage device to be stored into the selected sub data blocks may be determined according to the service logic. The loading procedure in this processing will be described in conjunction with the structure of system for storing data shown in FIG. 2.

In FIG. 2, the physical addresses of the shared memory are translated into the logic address of each of the service logic process and the data synchronizing proxy process during the configuration of the two-dimensional data buffer array, and thus the address of each of the sub data blocks in the two-dimensional data buffer array may be obtained by the service logic process and the data synchronizing proxy process. When the data on the network storage device is determined to be stored into the local shared memory according to the service logic, the service logic process selects at least one sub data block in the free status from all of the sub data blocks via a data interface of a device where the service logic process is located, obtains coordinates (N, n) of the sub data block to which data is to be loaded. Then a data loading message is sent to the data synchronizing proxy process by a message queue via the data interface of the device where the service logic process is located. The data loading message carries at least the coordinates of the selected sub data block, an operation type and an identifier for the data to be loaded, so that the data synchronizing proxy process will know what operation is to be performed to which sub data block. This processing is for loading data, and thus the operation type carried in the data loading message is “loading” and the identifier for the data to be loaded is used to identify the data in the network storage device to be loaded. In the example, the key value is taken as the identifier for each data, no matter whether the data is stored on the network storage device or stored in the local shared memory.

After receiving the data loading message, the data synchronizing proxy process selects an idle thread in a thread pool, and then the data to be loaded is acquired from the network storage device via the idle thread according to the key value of the data to be loaded carried in the data loading message. In the example, the network storage device stores all data in a database. For the purpose of improving data storage and data exchange efficiency, in the example, calling frequency of the data in the database is determined in advance, and then the data are sorted according to the calling frequency, such as from higher calling frequency to lower calling frequency, and the data having high calling frequency is stored in a buffer space, and thus the data to be loaded may be read by the thread in the data synchronizing proxy process directly from the buffer space, thereby improving the efficiency of reading data. According to an example, the thread in the data synchronizing proxy process may also directly operate the database if it is allowed by the system performance, and it is not limited by the example.

While acquiring the data to be loaded, the thread in the data synchronizing proxy process searches the buffer space for the data to be loaded according to the key value of the data to be loaded carried by the data loading message. If the buffer space includes the data to be loaded, the thread transmits the data to be loaded to the data synchronizing proxy process via a data synchronizing interface between the buffer space and the data synchronizing proxy process. If the buffer space does not include the data to be loaded, the thread searches the database for the data to be loaded, buffers the data to be loaded into the buffer space, and transmits the data to be loaded to the data synchronizing proxy process via the data synchronizing interface between the buffer space and the data synchronizing proxy process. After receiving the data to be loaded, either found from the buffer space directly or found from the database, the data synchronizing proxy process writes the data to be loaded into a corresponding sub data block, i.e., the sub data block corresponding to the coordinates carried by the data loading message, via a data interface of the data synchronizing proxy process. During the loading process, the data status of the sub data block to which data is being loaded is modified from the free status to the loading status. After the loading process is completed, the data status is modified from the loading status to the normal status. Thus, the procedure of loading the data stored on the network storage device to the local shared memory is ended. If the data is required to be called or operated subsequently, it can be done locally rather than by accessing the network storage device via the network. If the data loaded to the local shared memory need to be modified according to the service logic, a modifying process is as follows.

At 304, the data in the sub data block is modified according to the service logic.

According to an example, since the data stored in the local shared memory varies continuously as the system runs, it is likely that the data will be updated during subsequent data exchange, and thus, it is often that the data stored in the sub data block is modified. In the example, triggering conditions for modifying of the data are not limited. For example, the data stored in the sub data block may be modified according to the service logic when a role of a game player changes, or when the state of the role is switched between online and offline. When the data is modified, the service logic process may replace the data stored in the sub data block with the modified data via a data interface of a device where the service logic process is located. After modification is completed, the data status of the sub data block is modified from the normal status to the modify status.

At 305, the data status of each of the multiple sub data blocks is polled regularly, and if the data status of the data in the sub data block is the modify status, the data is synchronized to the network storage device.

According to an example, after the data in the sub data block of the two-dimensional data buffer array is modified, for the purpose of keeping data synchronization between the local shared memory and the network storage device and thus preventing data loss efficiently, the data status of each of the sub data blocks is polled regularly by the data synchronizing proxy process, and if the data status of the data in a sub data block is the modify status, the data is synchronized into the network storage device. According to an example, the data synchronizing proxy process regularly polls the data status of the head structure of each sub data block via a data interface of a device where the data synchronizing proxy process is located. If it is determined that the data status of a sub data block is modify status, which means that the data in the sub data block is modified data, the data synchronizing proxy process acquires the modified data and the key value of the modified data from the sub data block via a data interface of a device where the data synchronizing proxy process is located, and selects an idle thread from a thread pool. The data in the buffer space having the same key value with that of the modified data is replaced with the modified data via the idle thread. After that, the network storage device may immediately synchronize the modified data in the buffer space to the database, or may check the data updated in the buffer space and synchronize the data modified in a certain time period into the database one time.

According to an example, in order to prevent the cast that the same modified data is synchronized repeatedly to the network storage device in subsequent processing, after synchronizing the data in the sub data block whose data status is the modify status to the network storage device, the data synchronizing proxy process modifies the data status of the sub data block whose data status was the modify status to the normal status.

Further, according to an example, when the data in the sub data block of the two-dimensional data buffer array is modified frequently, the data needs to be synchronized into the network storage device frequently. If the data synchronizing proxy process has no sufficiency time to response, an overtime phenomenon may occur when synchronizing the data. To solve this problem, according to an example, a data synchronizing overtime time is configured according to a predetermined configuration policy, and the time spent by the data synchronizing proxy process in synchronizing the data is monitored. If the time spent by the data synchronizing proxy process in synchronizing the data exceeds the data synchronizing overtime time, a data service overtime status code may be returned to the service logic process via an data interface of a device where the service logic process is located, and the service logic process may determine whether to synchronize the data again.

In addition, besides the data synchronizing operation triggered by the modification of the data in the sub data block, according to the service logic, the data in the sub data block of the two-dimensional data buffer array may no longer vary as the system runs and thus permanence storage of the data is required. In order to achieve the permanence storage of the data, the following data synchronization operations are required.

At 306, the data in the sub data block is synchronized to the network storage device according to the service logic, and the shared memory corresponding to the sub data block is released.

The synchronization operation at 306 is different from that at 305. The synchronization operation at 305 is triggered by the modification of data in a sub data block of the two-dimensional data buffer array, so as to keep data consistency between the local shared memory and the network storage device. The synchronization operation at 306 is triggered in the case that it is determined according to the service logic that data in a sub data block of the two-dimensional data buffer array no longer vary as the system runs and the permanence storage of the data is required. Since the data will not vary as the system runs, and thus the shared memory occupied by such data may be released.

According to an example, as shown in FIG. 2, when the service logic needs to release memory space, the data status of the sub data block storing the data to be removed is modified via an data interface of a device where the service logic process is located called by the service logic process, i.e., the data status of the sub data block storing the data to be removed is modified from the normal status to the remove status, and then a data synchronizing releasing message is sent to the data synchronizing proxy process through a message queue via the data interface. The data synchronizing releasing message carries coordinates of the sub data block storing the data to be removed, an operation type and an identifier of the data to be removed, so that the data synchronizing proxy process may determine what operation is to be performed to which sub data block. Since this operation is synchronizing releasing operation, the operation type carried in the data synchronizing releasing message is “remove”, and the identifier of the data to be removed is used to identify the data to be removed in the sub data block of the two-dimensional data buffer array. According to an example, the key value is taken as the identifier of each data, no matter whether the data is stored on the network storage device or stored in the local shared memory.

After receiving the data synchronizing releasing message, the data synchronizing proxy process obtains the data from the sub data block corresponding to the coordinates carried in the data synchronizing releasing message by calling an data interface of a device where the data synchronizing proxy process is located, and selects an idle thread in a thread pool, so that the data obtained from the sub data block is synchronized to the database in the network storage device via the idle thread, and stored by the database over a prolonged period.

According to an example, during data synchronizing releasing operation performed by the data synchronizing proxy process, the data interface of a device where the service logic process is located regularly detects whether the data is removed completely. If it is detected that no data is included in the sub data block corresponding to the coordinates carried in the data synchronizing releasing message, it is determined that the removing is completed, i.e., the shared memory occupied by the sub data block is released. The data status of the sub data block is modified to the free status from the remove status, and thus the sub data block may be reassigned for loading data. If it is detected that the sub data block corresponding to the coordinates carried in the data synchronizing releasing message includes data, it is determined that the removing is not completed. If the removing is not completed after a predetermined period, it is determined that the removing fails, i.e., the shared memory occupied by the sub data block is not released successfully, and the data status of the sub data block is modified to the tick_remove status from the remove status. The predetermined period is not limited in the example.

According to an example, if the data status of the sub data block is the tick_remove, to release the shared memory occupied by the sub data block successfully, the data status of each sub data block is queried regularly by the data synchronizing proxy process. If the sub data block having the data status of the tick_remove is found, the processing of synchronizing the data of the sub data block into the network storage device performed by the data synchronizing proxy process is triggered. After the data interface of the device where the service logic process is located detects that the data in the sub data block having the data status of the tick_remove status is removed successfully, the data status of the sub data block is modified to the free status from the tick_remove status, so that the sub data block may be reassigned for loading data.

According to the methods provided by the examples of the present disclosure, the data is stored locally by configuring the extendable two-dimensional data buffer array in the local shared memory according to the preset configuration policy and storing the data on the network storage device into the sub data block corresponding to the data according to the requirements of the service logic, thereby improving the efficiency of data storage and data exchange. The extendibility of the data structure is improved since the two-dimensional data buffer array for storing data is extendable, and thus the requirements of the service logic are satisfied. In addition, the data in the local shared memory and the network storage device are synchronized by synchronizing modified data to the network storage device after the data in the data block is modified, and thus data loss is avoided.

According to an example of the present disclosure, an apparatus for storing data is provided. The apparatus is used to perform the method for storing data according to the above example. Referring to FIG. 7, the apparatus includes a configuring module 701 and a loading module 702.

The configuring module 701 is to configure an extendable two-dimensional data buffer array in a local share memory according to a preset configuration policy. The two-dimensional data buffer array includes multiple logic data blocks, and each of the multiple logic data blocks includes multiple sub data block for storing data.

The loading module 702 is to store data on a network storage device into a sub data block corresponding to the data according to the requirement of service logic.

The local shared memory refers to a large capacity memory which may be accessed by different CPUs in a computer system with multiple processors. The local shared memory may be read or written directly, thereby improving the processing efficiency of the processors. The operations performed by the configuring module 701 for configuring the extendable two-dimensional data buffer array in the local shared memory may refer to the processing at 301 in the above example, which will not be described herein.

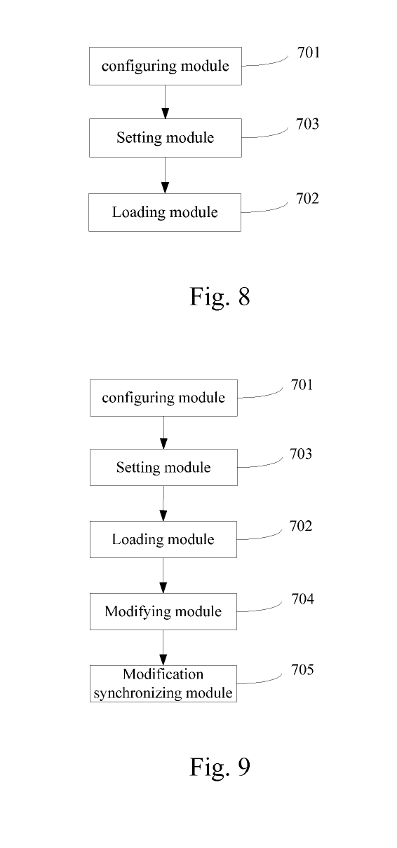

Referring to FIG. 8, the apparatus may further include a setting module 703. The setting module 703 is to set a data status for each of the multiple sub data blocks according to data storage situation in each of the multiple sub data blocks. The data status is one of: a free status, a loading status, a normal status, a modify status, a remove status and a tick_remove status. The operations performed by the setting module 703 for setting the data status may refer to the processing at 302 described in the above example, which will not be described herein.

Referring to FIG. 9, the apparatus may further include a modifying module 704 and a modification synchronizing module 705. The modifying module 704 is to modify the data stored in the sub data block according to service logic. The modification synchronizing module 705 is to synchronize the data modified by the modifying module 704 to the network storage device.

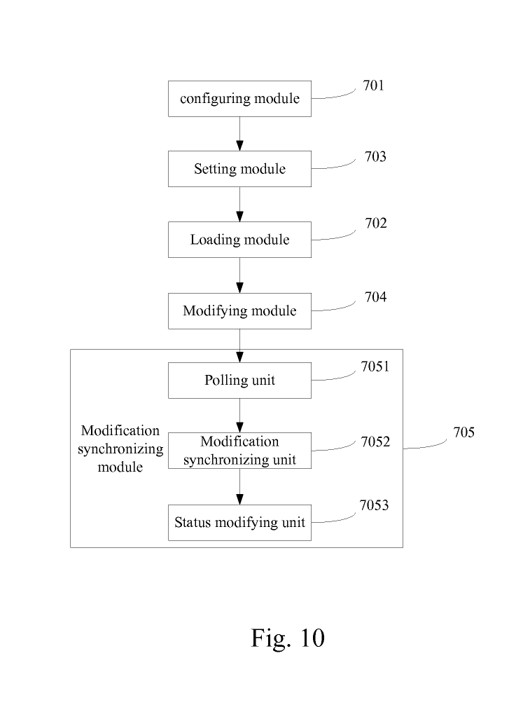

Referring to FIG. 10, the modification synchronizing module 705 includes a polling unit 7051 and a modification synchronizing unit 7052. The polling unit 7051 is to regularly poll the data status of each of the multiple sub data blocks. The modification synchronizing unit 7052 is to synchronize the data in the sub data block having the data status of the modify status polled by the polling unit 7051 to the network storage device. According to an example, the modification synchronizing module 705 further includes a status modifying unit 7053 to modify the data status of the sub data block from the modify status to the normal status. The operations performed by the polling unit of the modification synchronizing module 705 for polling the data status of the sub data blocks and the operations performed by the modification synchronizing unit 7052 for modifying the data may refer to the processing at 304 in the above example, which will not be described repeatedly herein.

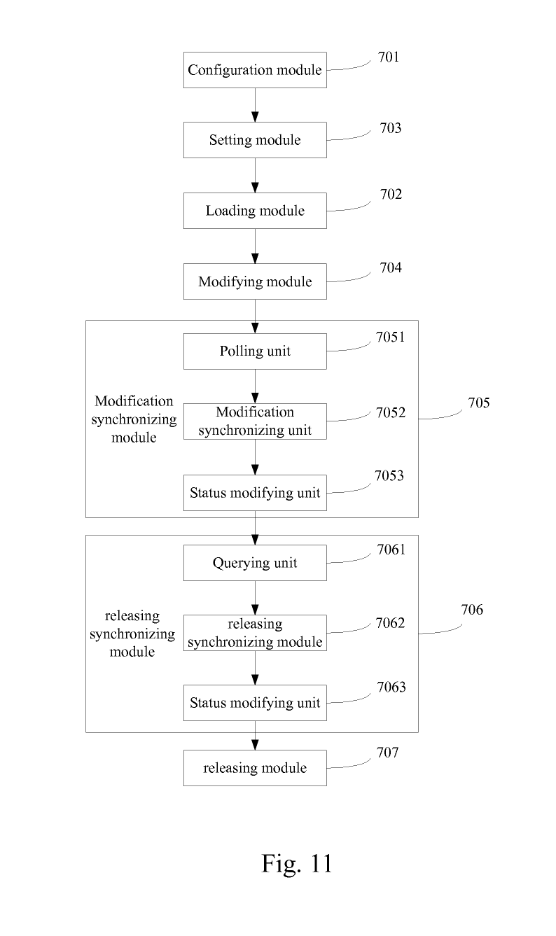

Referring to FIG. 11, the apparatus may further include a releasing synchronizing module 706 and a releasing module 707.

The releasing synchronizing module 706 is to synchronize the data in the sub data block to the network storage device according to service logic. The releasing module 707 is to remove the shared memory corresponding to the sub data block, after the releasing synchronizing module 706 synchronizes the data in the sub data block to the network storage device according to the service logic.

Further, referring to FIG. 11, the releasing synchronizing module 706 includes a querying unit 7061 and a releasing synchronizing unit 7062. The querying unit 7061 is to query the data status of each of the multiple sub data blocks. The releasing synchronizing unit 7062 is to synchronize the data in the sub data block having the data status of the tick_remove status queried by the querying unit to the network storage device. Further, the releasing synchronizing module 706 further includes a status modifying unit 7063 to modify the data status of the sub data block having the data status of the tick_remove status to the normal status. The operations performed by the querying unit 7061 for querying the data status and the operations performed by the releasing synchronizing unit 7062 may refer to the processing at 305 in the above example, which will not be described herein.

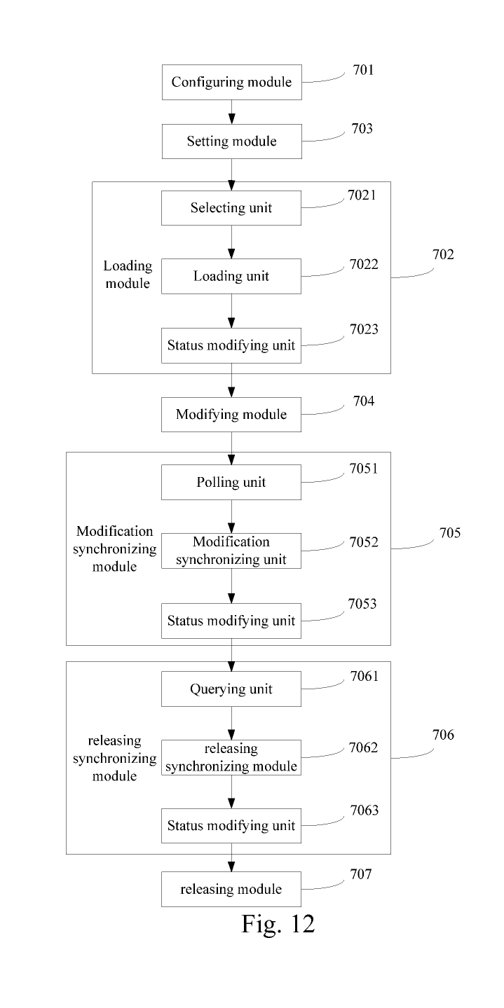

Referring to FIG. 12, the loading module 702 includes a selecting unit 7021 and a loading unit 7022. The selecting unit 7021 is to select a sub data block having the data status of the free status from all of the multiple sub data blocks. The loading unit 7022 is to store the data stored on the network storage device into the sub data block selected by the selecting unit 7021 according to requirements of service logic. Further, the loading module 702 further includes a status modifying unit 7023 to modify the data status of the selected sub data block from the free status to the loading status. After the loading of the data is completed, the status modifying unit 7023 is to modify the data status of the selected sub data block from the loading status to the normal status. The manner used by the selecting unit 7021 for selecting the sub data block and the operations performed by the loading unit 7022 for loading data may refer to the processing at 303 in the above example, which will not be described herein.

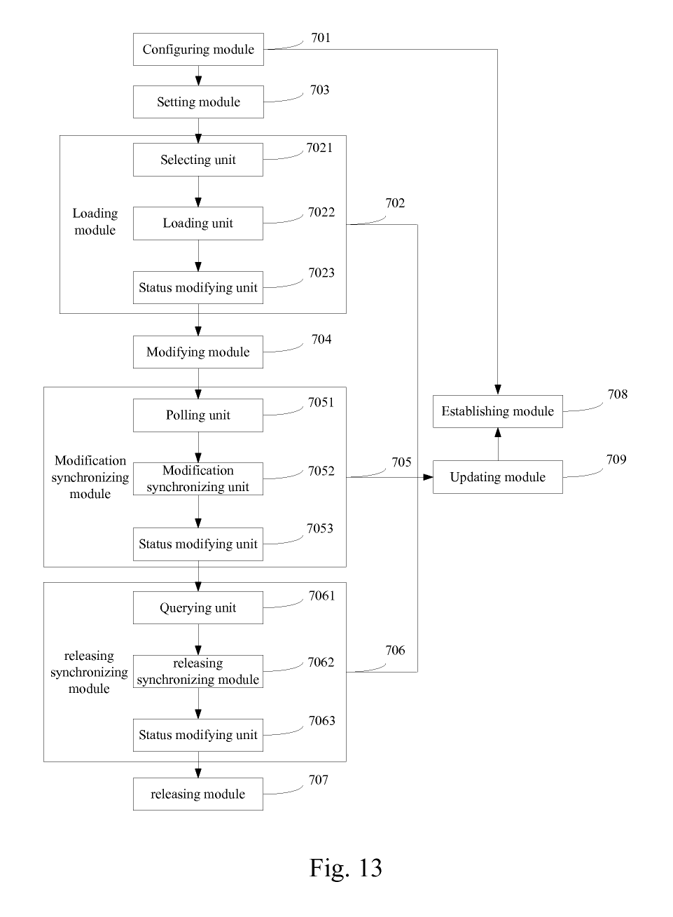

Referring to FIG. 13, the apparatus further includes an establishing module 708 and an updating module 709. The establishing module 708 is to establish a relationship table between the two-dimensional data buffer array and the network storage device, and record data storage situation of each of the sub data blocks of the two-dimensional data buffer array. The relationship table is stored on the network storage device. The updating module 709 is to update the relationship table according to data variation in the sub data blocks of the two-dimensional data buffer array. Each of the logic data blocks in the two-dimensional data buffer array corresponds to one relationship table, and each of the sub data blocks in the logic data block corresponds to a record in the relationship table.

According to the apparatus provided by the examples of the present disclosure, the data is stored locally by configuring the extendable two-dimensional data buffer array in the local shared memory according to the preset configuration policy and storing the data on the network storage device into the sub data block corresponding to the data according to the requirements of the service logic, thereby improving the efficiency of data storage and data exchange. The extendibility of the data structure is improved since the two-dimensional data buffer array for storing data is extendable, and thus the requirements of the service logic are satisfied. In addition, the data in the local shared memory and the network storage device are synchronized by synchronizing modified data to the network storage device after the data in the data block is modified, and thus data loss is avoided.

It is to be noted that, when storing data, the apparatus for storing data according to the example is divided into function modules by way of example only. In practice, the functions may be performed by different function modules as required, i.e., the internal structure of the apparatus may be divided into different functional modules to perform all or part functions described above. In addition, the apparatus for storing data according to the example and the method for storing data belongs to a general concept; the examples related to the apparatus will not be described herein.

The methods, modules and devices described herein may be implemented by hardware, machine-readable instructions or a combination of hardware and machine-readable instructions. Machine-readable instructions used in the examples disclosed herein may be stored in storage medium readable by multiple processors, such as hard drive, CD-ROM, DVD, compact disk, floppy disk, magnetic tape drive, RAM, ROM or other proper storage device. Or, at least part of the machine-readable instructions may be substituted by specific-purpose hardware, such as custom integrated circuits, gate array, FPGA, PLD and specific-purpose computers and so on.

A machine-readable storage medium is also provided, which is to store instructions to cause a machine to execute a method as described herein. Specifically, a system or apparatus having a storage medium that stores machine-readable program codes for implementing functions of any of the above examples and that may make the system or the apparatus (or CPU or MPU) read and execute the program codes stored in the storage medium.

In this situation, the program codes read from the storage medium may implement any one of the above examples, thus the program codes and the storage medium storing the program codes are part of the technical scheme.

The storage medium for providing the program codes may include floppy disk, hard drive, magneto-optical disk, compact disk (such as CD-ROM, CD-R, CD-RW, DVD-ROM, DVD-RAM, DVD-RW, DVD+RW), magnetic tape drive, Flash card, ROM and so on. Optionally, the program code may be downloaded from a server computer via a communication network.

It should be noted that, alternatively to the program codes being executed by a computer, at least part of the operations performed by the program codes may be implemented by an operation system running in a computer following instructions based on the program codes to realize a technical scheme of any of the above examples.

In addition, the program codes implemented from a storage medium are written in a storage in an extension board inserted in the computer or in a storage in an extension unit connected to the computer. In this example, a CPU in the extension board or the extension unit executes at least part of the operations according to the instructions based on the program codes to realize a technical scheme of any of the above examples.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

1. A method for storing data, comprising:
configuring an extendable two-dimensional data buffer array in a local shared memory according to a preset configuration policy; the two-dimensional data buffer array comprising multiple logic data blocks, and each of the multiple logic data blocks comprising multiple sub data blocks for storing data; and
storing data on a network storage device into a sub data block corresponding to the data according to requirements of service logic.

2. The method of claim 1, after configuring the extendable two-dimensional data buffer array in the local shared memory according to the preset configuration policy, further comprising:
setting a data status for each of the multiple sub data blocks according to data storage situation in each of the multiple sub data blocks; the data status comprising one of a free status, a loading status, a normal status, a modify status, a remove status and a tick_remove status.

3. The method of claim 2, after storing data on the network storage device into the sub data block corresponding to the data according to the requirements of the service logic, further comprising:
modifying data stored in one sub data block according to service logic, and synchronizing the data modified to the network storage device.

4. The method of claim 3, wherein synchronizing the data modified to the network storage device comprises:
polling the data status of each of the multiple sub data blocks regularly, and synchronizing data in a sub data block to the network storage device when a data status of the sub data block is a modify status.

5. The method of claim 4, after synchronizing the data in the sub data block to the network storage device, the method further comprising: modifying the data status of the sub data block from a modify status to a normal status.

6. The method of claim 2, after storing the data on the network storage device into the sub data block corresponding to the data according to the requirements of the service logic, further comprising:
synchronizing data in one sub data block to the network storage device according to service logic, and releasing shared memory corresponding to the sub data block.

7. The method of claim 6, wherein synchronizing the data in the sub data block to the network storage device according to the service logic comprises:
querying the data status of each of the multiple sub data blocks; and synchronizing data in one sub data block to the network storage device when a data status of the sub data block is a tick_remove status.

8. The method of claim 7, after synchronizing the data in the sub data block to the network storage device, the method further comprising: modifying the data status of the sub data block from a tick_remove status to a normal status.

9. The method of claim 2, wherein storing the data on the network storage device into the sub data block corresponding to the data according to the requirements of the service logic comprises:
selecting a sub data block having a data status of a free status from all of the multiple sub data blocks, and storing the data on the network storage device into the selected sub data block according to the requirements of the service logic.

10. The method of claim 9, after storing the data on the network storage device into the selected sub data blocks, further comprising:
modifying the data status of the selected sub data block from a free status to a loading status; and
modifying the data status of the selected sub data block from the loading status to a normal status after the loading of the data is completed.

11. The method of claim 1, after configuring the extendable two-dimensional data buffer array in the local shared memory according to the preset configuration policy, further comprising:
establishing a relationship table between the two-dimensional data buffer array and the network storage device; and updating the relationship table according to data variation in the sub data blocks of the two-dimensional data buffer array; the relationship table being stored on the network storage device and recording data storage situation of each of the sub data blocks of the two-dimensional data buffer array; and each of the logic data blocks in the two-dimensional data buffer array corresponding to one relationship table, and each of the sub data blocks in the logic data block corresponding to one record in the relationship table.

12. An apparatus for storing data, comprising:
a configuration module, configured to configure an extendable two-dimensional data buffer array in a local shared memory according to a preset configuration policy; the two-dimensional data buffer array comprising multiple logic data blocks, and each of the multiple logic data blocks comprising multiple sub data blocks for storing data; and
a loading module, configured to storing data on a network storage device into a sub data block corresponding to the data according to requirements of service logic.

13. The apparatus of claim 12, further comprising:
a setting module, configured to set a data status for each of the multiple sub data blocks according to data storage situation in each of the multiple sub data blocks; the data status comprising one of a free status, a loading status, a normal status, a modify status, a remove status and a tick_remove status.

14. The apparatus of claim 13, further comprising:
a modifying module, configured to modify data stored in one sub data block according to service logic; and
a modification synchronizing module, configured to synchronize the data modified by the modifying module to the network storage device.

15. The apparatus of claim 14, wherein the modification synchronizing module comprises:
a polling unit, configured to poll the data status of each of the multiple sub data blocks regularly; and
a modification synchronizing unit, configured to synchronize data in a sub data block to the network storage device, when a data status of the sub data block polled by the polling unit is a modify status.

16. The apparatus of claim 15, wherein the modification synchronizing module further comprises:
a status modifying unit, configured to modify the data status of the sub data block from a modify status to a normal status.

17. The apparatus of claim 13, further comprising:
a releasing synchronizing module, configured to synchronize data in one sub data block to the network storage device according to service logic; and
a releasing module, configured to release shared memory corresponding to the sub data block, after the releasing synchronizing module synchronizes the data in the sub data block to the network storage device according to the service logic.

18. The apparatus of claim 17, wherein the releasing synchronizing module comprises:
a querying unit, configured to query the data status of each of the multiple sub data blocks; and
a releasing synchronizing unit, configured to synchronize the data in one sub data block to the network storage device, when a data status of the sub data block queried by the querying unit is a tick_remove status.

19. The apparatus of claim 18, wherein the releasing synchronizing module further comprises:
a status modifying unit, configured to modify the data status of the sub data block from a tick_remove status to a normal status.

20. The apparatus of claim 13, wherein the loading module comprises:
a selecting unit, configured to select a sub data block having a data status of a free status from all of the multiple sub data blocks; and
a loading unit, configured to store the data stored on the network storage device into the sub data block selected by the selecting unit according to the requirements of the service logic.

21. The apparatus of claim 20, wherein the loading module further comprising:
a status modifying unit, configured to modify the data status of the sub data block selected by the selecting unit from a free status to a loading status; and modifying the data status of the sub data block selected by the selecting unit from the loading status to a normal status after the loading of the data is completed.

22. The apparatus of claim 12, further comprising:
an establishing module, configured to establish a relationship table between the two-dimensional data buffer array and the network storage device; the relationship table being stored on the network storage device and recording data storage situation of each of the sub data blocks of the two-dimensional data buffer array; and
an updating module, to update the relationship table according to data variation in the sub data blocks of the two-dimensional data buffer array;
wherein each of the logic data block in the two-dimensional data buffer array corresponds to one relationship table, and each of the sub data blocks in the logic data block corresponds to one record in the relationship table.
